(19) United States
(12) Patent Application Publication
(10) Pub. No.: US 2016/0096125 A1
(43) Pub. Date: Apr. 7, 2016

(54) SLUDGE CLASSIFICATION PRESS HAVING A ROTATIONALLY ADJUSTABLE SEPARATION SCREEN

(71) Applicant: ClearCove Systems, Inc., Rochester, NY (US)

(72) Inventor: Terry Wright, Rochester, NY (US)

(21) Appl. No.: 14/754,924

(22) Filed: Jun. 30, 2015

Related U.S. Application Data
(63) Continuation-in-part of application No. 14/503,526, filed on Oct. 1, 2014.

(51) Int. Cl. B01D 29/96; B01D 35/30

(52) U.S. Cl. CPC B01D 29/96; B01D 35/30

(57) ABSTRACT

An improved sludge classifying press for isolating biologically-digestible materials from sludge. The press comprises a tubular shell containing a cylindrical separation screen and a tapered auger driven within the separation screen by a motor and transmission. The SCP assists in fracturing the protective casings of resistant seeds and passing the resulting comminuted solid materials in a liquid stream of BOD materials. The separation screen may be repositioned with respect to the tubular shell by rotation to distribute wear by grit impingement that occurs during use preponderantly at the bottom of the screen, thereby extending the working life of the screen.

### RELATIONSHIP TO OTHER APPLICATIONS AND PATENTS

The present application is a Continuation-In-Part of pending U.S. patent application Ser. No. 14/503,526, METHOD AND APPARATUS FOR SEPARATING BIOLOGICALLY DIGESTIBLE MATERIALS FROM AN INFLUENT STREAM, filed Oct. 1, 2014, the relevant disclosure of which is incorporated herein by reference.

### TECHNICAL FIELD

The present invention relates to systems for processing waste water; more particularly, to such systems for separating biologically-digestible materials from indigestible materials in sewage; and most particularly to improved methods and apparatus for classifying sludge using an improved sludge classifying press.

In the arts dealing with decomposition of organic materials, biologically-digestible materials typically are quantified by the demand that aerobic digestion thereof places on the available oxygen supply, hence the term “Biological Oxygen Demand” (BOD). For simplicity of presentation as used herein, biologically-digestible materials are also referred to simply as “BOD”.

### BACKGROUND OF THE INVENTION

The historical primary objective of waste water treatment operations has been to neutralize and otherwise render sewage effluence disposable in compliance with regulatory limits based on environmental and health standards.

In prior art sewage treatment processes employing conventional sludge presses, such as the Strainpress® Sludgecleaner SP manufactured by Huber Technology, the overarching treatment strategy is to separate solids from liquids; sanitize the liquids for disposal in a natural watercourse, artificial lagoon, or spray field; and remove excess water from the solids for landfill disposal. The sludge press is used to separate out excess water by forcing the water along with dissolved solids through a relatively fine-pore cylindrical or conical screen. To facilitate this process, it is common practice to dose the fluid with thickening agents in advance of the sludge entering the press. The combination of these conventional mechanical and chemical processes results in retaining most of the sludge solids, both biodegradable and non-biodegradable, within the sludge press, and then passing the de-watered solid material through a valve at the distal end of the screen.

Typically, a preponderance of grit and other indigestible materials is removed from the influent stream in a first prior step. The influent stream is then thickened in a second prior step by addition of thickening agents before entering the sludge press. Typically this is considered solid waste and is hauled off to a landfill.

This prior art approach to sludge treatment does not recover energy-potential that is contained in the biodegradable solid components of the sludge. Instead, the energy-rich BOD is typically lost in the dewatered solids that are discarded to landfills.

Historically, the focus of the prior art treatment processes just described has been to ensure effluent discharge remains in compliance with public and environmental standards. In addition to this objective, important and growing objectives of modern waste water treatment systems are (a) reduction of energy usage for treatment processes, and (b) recovery of energy from BOD present in the waste water itself. The recovered energy can offset significantly the overall cost of the treatment process.

### SUMMARY OF THE INVENTION

Briefly described, a system in accordance with the present application comprises method and apparatus for separating, and enhancing the separation of, biologically-digestible materials from an influent sewage stream.

In one aspect of the present invention, a raw sludge influent optionally may be passed through an Enhanced Primary Treatment (EPT) primary clarification tank to separate BOD-containing sludge from non-digestible floating materials and from coarse grit.

In another aspect of the present invention, an improved sludge classifying press (SCP) is used to isolate and concentrate (“classify”) biologically-digestible materials from sludge, either with or without previous treatment in a primary clarification tank. Classified sludge typically contains valuable solid and dissolved organic materials, such as are found in corn kernels, bean pods, and other seeds. The SCP assists in squeezing and fracturing the protective casings of resistant seeds and passing the resulting comminuted solid materials in the liquid stream of BOD materials.

In another aspect of the present application, the sludge undergoes primary thickening after classification by the SCP to minimize loss of digestible materials that will otherwise be retained undesirably in the core stream of discarded solids, as in the prior art. Such improvement in the treatment process maximizes recovery of desirable digestible materials in liquid being expressed from the SCP to be further processed for energy generation/recovery.

In another aspect of the present invention, the pressure surfaces of the screw flights in an SCP are at least partially covered by elastomeric shields to minimize wear on the screw surfaces.

In another aspect of the present invention, the separation screen of an SCP may be repositioned by rotation to distribute wear that occurs during use preponderantly at the bottom of the screen.

In another aspect of the present invention, the screw is self-centered within the separation screen, eliminating need for an active shaft bearing at the non-driven end of the screw.

In another aspect of the present invention, the screw may be driven intermittently to maintain pressure generated within the separation screen as the liquid content of the sludge is separated from the non-digestible solid content and is passed through the screen.

In another aspect of the present invention, the pore size of the separation screen is much larger than in prior art sludge presses to allow desired passage of BOD solids through the screen, in contrast to the prior art.

### BRIEF DESCRIPTION OF THE DRAWINGS

The present invention will now be described, by way of example, with reference to the accompanying drawings, in which:

FIG. 1 is an isometric view from above, in partial cutaway for clarity, of an embodiment of a sludge classifying press in accordance with the present invention;

FIG. 2 is an elevational transverse cross-sectional view of the sludge classifying press shown in FIG. 3, taken along line 2-2; and

FIG. 3 is a longitudinal elevational cross-sectional view of the sludge classifying press shown in FIG. 1.

### DETAILED DESCRIPTION OF THE INVENTION

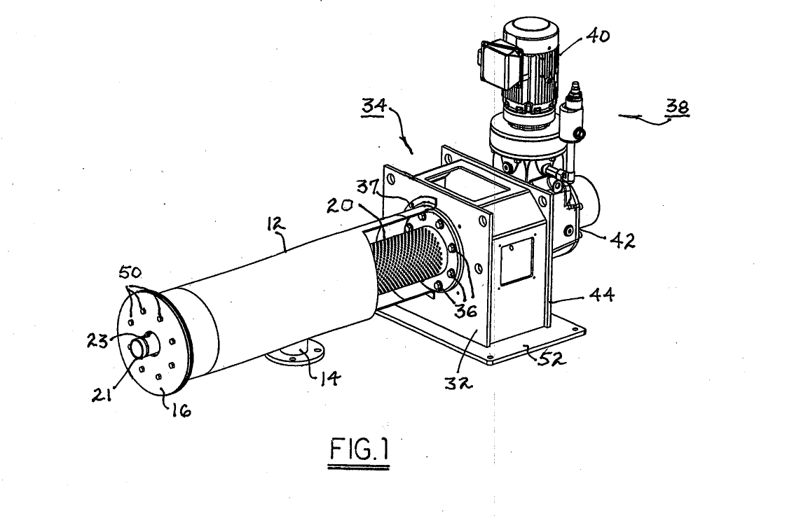

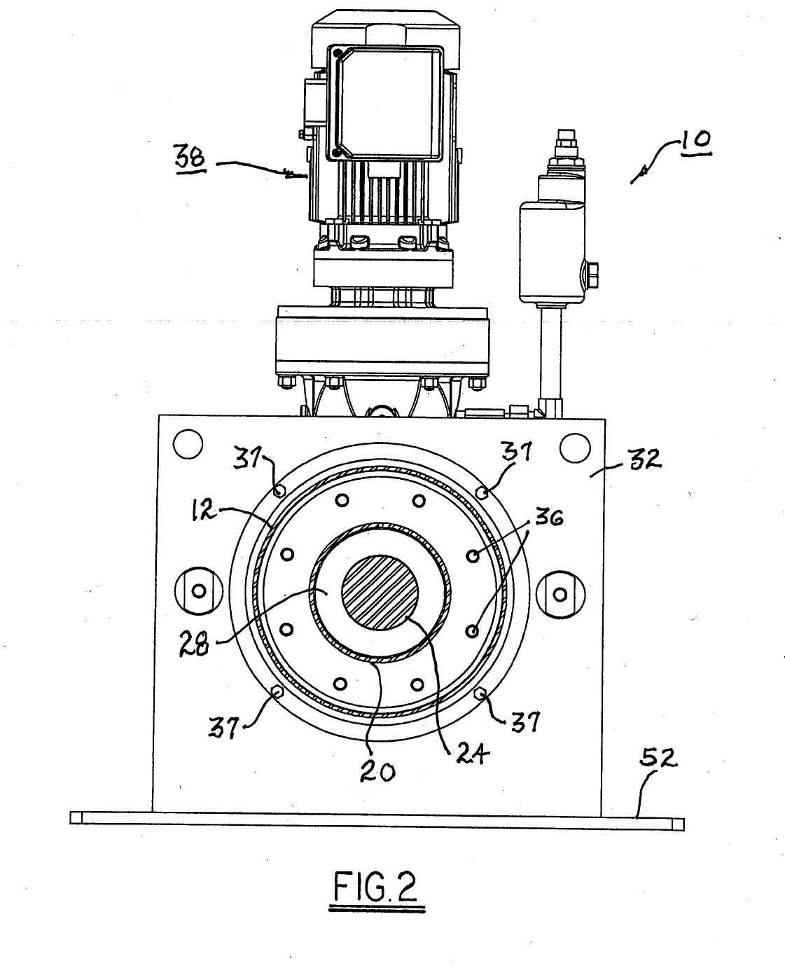

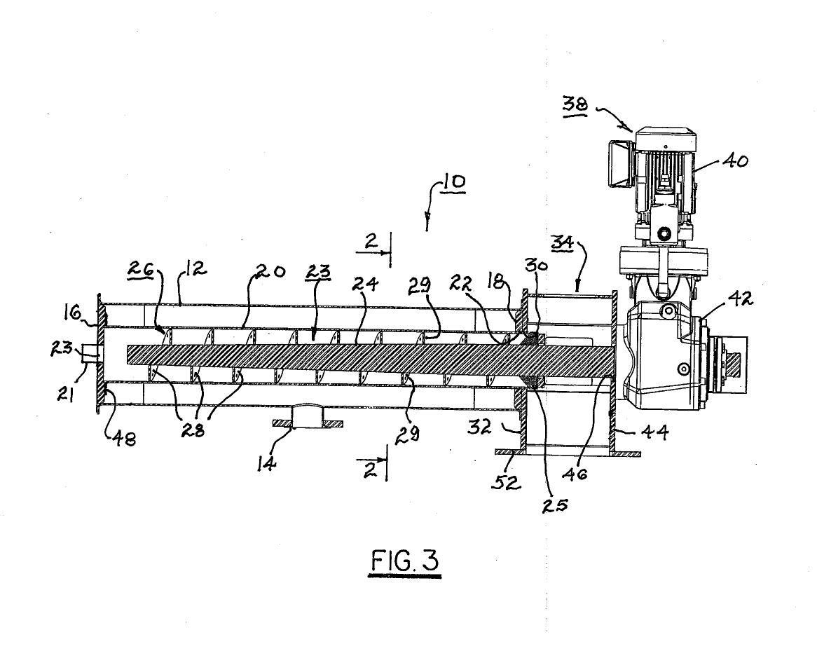

Referring now to FIGS. 1 through 3, a currently-preferred embodiment 10 of a sludge classifying press (SCP) assembly in accordance with the present invention comprises a tubular shell 12 having a flanged sludge drain port 14 and first and second end plates 16,18; a cylindrical screen 20 axially disposed within shell 12 and protruding through a central opening 22 in second end plate 18; and an auger 23 having a tapered shaft 24 axially disposed within screen 20 and having a screw 26 comprising spaced-apart flights 28 of decreasing radial height supported by shaft 24 and disposed between shaft 24 and screen 20. A threaded feed nipple 21 is mated to a central opening 23 in first end plate 16. Screen 20 and shaft 24 extend through an opening 30 in a first side wall 32 of a sludge box 34 that forms the principal supporting member for the entire SCP assembly 10. Second end plate 18 is attached as by bolts 36 to first side wall 32. Tubular shell 12 is attached to second side wall 44 as by bolts 37. A drive assembly 38 comprising at least an electric motor 40 and transmission 42 is attached as by bolts (not visible) to a second side wall 44 of sludge box 34. Shaft 24 is attached to transmission 42 via an opening 46 in second side wall 44.

Screen 20 includes a terminal flange 48 that is bolted to first end plate 16 by bolts 50 which are distributed preferably in a circularly symmetric pattern of holes or detents, exemplarily octagonal as shown in FIG. 1. During use of SCP assembly 10, the inner surface of screen 20 will tend to experience maximal wear at the lowest gravitational position (“bottom”) of the screen due to gravitational settling of heavier and abrasive compounds such as grit and sand.

To extend the working lifetime of screen 20, the screen may be repositioned by rotation periodically as desired to bring a less-worn inner surface into the lowest gravitational position, incrementally turning the screen axially a pre-set angular shift such as 45° or less, and re-inserting the bolts. Such rotation may be performed in increments of at least one degree (1°). In the currently preferred embodiment, rotation is accomplished by removing bolts 36 and 50, turning the screen axially 45°, and re-inserting the bolts. Other screen mounting embodiments, not shown but fully anticipated by the invention and readily apparent to those of ordinary skill in the art, include a motor-driven screen rotation and clamping the screen in position rather that bolting the screen to first end plate 16.

An important advantage of the present invention is the ease of rotation of screen 20 by the SCP operators which in turn promotes pre-emptive maintenance/rotation by operators on a frequent/monthly basis. In typical prior art practices for prior art presses, the press screen must be replaced by maintenance professionals at substantial billable cost to the operations facility. The present invention enables user-based maintenance which significantly extends screen working life and improves operating cost.

Screen 20 is closed within sludge box 34 by an adjustable conical plug defining a valve 25 that may be loaded by any means, such as spring or hydraulic or pneumatic.

Sludge box 34 preferably includes a base plate 52 supportive of the remainder of the apparatus of SCP assembly 10. Optionally, one or more additional supports (not shown) may be provided for shell 12 and/or first end plate 16, configured for any specific application.

In operation, an SCP assembly 10 in accordance with the present invention is essentially an auger 23 encased in a cylindrical screen 20 and configured to cause a progressively-decreasing cavity bounded by screen 20, tapered auger shaft 24, and adjacent flights 28 of auger screw 26. Sludge rich in BOD content flows into SCP assembly 10 via axial feed nipple 21, with or without prior treatment in one or more other elements of a sewage treatment system (not shown). Within SCP screen 20, the sludge is increasingly compressed as it advances axially along the space between cylindrical screen 20 and tapered shaft 24, driven by rotation of auger 23.

Within SCP assembly 10, a water portion of the sludge rich in suspended BOD passes radially through screen 20 to be subsequently dewatered, e.g, by thickening and filtration, and fed to a digester to generate methane. Large non-digestibles continue to be advanced axially with the SCP assembly to form a relatively dry “cake” that is expelled from screen 20 via valve 25 into sludge box 34 and collected for disposal.

Flights 28 of screw 26 preferably are armored on their downstream or pressure side with a replaceable elastomeric shield 29 to protect the screw itself from abrasive wear. Rubber shield 29 is more durable and less expensive than prior art ceramic screw shields that are expensive to form and require significant machining and fitting to install.

Further, elastomeric shield 29 preferably is formed to cover the entire pressure-side surface of screw 28 from shaft 24 to screen 20, rather than just the outer portions of the screw surface as in the prior art.

Further, elastomeric shield 29 is formed to engage the inner surface of screen 20 and thus acts as a squeegee to assist in squeezing and breaking resistant seeds into smaller pieces and their extruded organic contents and urging the resulting pieces through screen 20 with the liquid stream.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A sludge classifying press, comprising: a tubular shell having at least one fixed end plate having an opening; and a cylindrical screen disposed within said shell and removably attached to said at least one fixed end plate and surrounding said opening, wherein said tubular shell, said at least one fixed end plate, and said cylindrical screen are non-rotational during a period of operation of said sludge classifying press, and wherein a rotational position of said cylindrical screen with respect to said tubular shell is adjustable during a period of non-operation of said sludge classifying press.

2. A sludge classifying press in accordance with claim 1 wherein said cylindrical screen is attached to said at least one end plate by a plurality of bolts.

3. A sludge classifying press in accordance with claim 2 wherein said bolts are arranged in a pattern of bolt holes through said cylindrical screen and said at least one end plate.

4. A sludge classifying press in accordance with claim 3 wherein said pattern is octagonal, permitting rotation of said cylindrical screen in increments measurable in degrees of rotation.

5. A sludge classifying press in accordance with claim 4 wherein at least one of said increments is 45 degrees.

6. A sludge classifying press in accordance with claim 1 wherein said rotational positional is adjustable in increments of at least one degree.
